(19) United States
(12) Patent Application Publication
(10) Pub. No.: US 2009/0283419 A1
(43) Pub. Date: Nov. 19, 2009

(54) Catalyst Consisting of a Solid Support, an Oxide and a Metal Active Phase Which is Grafted on the Oxide, a Method for the Preparation and the Use Thereof

(75) Inventors: Pascal Del-Gallo, Dourdan (FR); Nicolas Richet, Fontenay-Le-Fleury (FR)

Correspondence Address: AIR LIQUIDE;Intellectual Property, 2700 POST OAK BOULEVARD, SUITE 1800, HOUSTON, TX, 77056, US

(73) Assignee: L'Air Liquide Societe Anonyme Pour L'Etude Et L'Exploitation Des Procedes Georges Claude, Paris (FR)

(21) Appl. No.: 12/096,498

(22) PCT Filed: Nov. 30, 2006
(86) PCT No.: PCT/EP2006/069169

§ 371 Date: Jun. 6, 2008

(30) Foreign Application Priority Data
Dec. 7, 2005 (EP) 05301022.9

(51) Int. Cl. C25B 1/02; B01J 23/10

(52) U.S. Cl. 205/628; 502/303; 502/304; 502/302

(57) ABSTRACT

A catalyst assembly for catalyzing chemical reactions in a gas phase consists of a solid support, whose surface (S) is provided with an anchorage oxide (O) which is chemically different therefrom and is fixed thereto, wherein said anchorage oxide covers a non-zero area percentage of said solid support (S) surface and of a metal phase (M) catalytically active for the considered chemical reaction, is characterized in that said catalytically active metal phase (M) is anchored to said solid support (S) by means of the anchorage oxide (O) which is also grafted on the solid support (S).

The invention belongs to the field of supported catalysts and their anchorage on substrates.

The initial microstructure of a catalyst, in particular the dispersion and size of particles of the active phase, as well as physical and chemical interactions between these and the support, play an essential role in efficiency and stability over time. One of the degradation modes of catalytic activity is the coalescence of particles of active phase, generally noble metals, such as platinum, rhodium or palladium, or transition metals such as nickel or cobalt.

Catalytic materials are widely used in industry for accelerating chemical reactions, in particular those between gaseous phases. Mention may be made for example of the production of synthesis gas (H₂+CO) by reforming methane on a catalytic bed, recombination with oxygen after separation through a membrane and also the reaction between H₂ and O₂ in fuel cells.

The catalysts employed generally consist of two phases, an active phase, often a noble metal such as platinum, rhodium or palladium, or a transition metal such as nickel or cobalt, and a support, more often a ceramic oxide that is inert toward the reaction to be catalyzed, such as alumina (Al₂O₃) or mixed oxides of aluminum and magnesium or aluminum and calcium (MgAl₂O₄; CaO—Al₂O₃).

The geometry of the support has been the subject of many works (A. S. Bodke, S. S. Bharadwaj, L. D. Schmidt. 1998, J. of Cata. 179, p 138-149; patent of United States of America published under U.S. Pat. No. 6,726,853; international application published under number WO 02/066371). In point of fact, the developed surface area is an important parameter for the efficiency of the catalyst (in reality the dispersion and size of the metal particles). Reference is made to the number of metal sites/g of catalyst (measurement carried out by chemisorption of CO and/or H₂, FEG, etc.). At the present time, ceramic supports, or even metal supports in some cases, are encountered for catalysts in the form of more or less porous or foamed cylinders, pellets or monoliths.

However, these catalysts undergo a phenomenon of deactivation with time that leads to a reduction in their performance. In general, this deactivation is observed by a fall in the reaction yield (product of conversion and selectivity), that is to say either by a reduction in the conversion rate of reactants and/or by modification of the selectivity of the products formed.

Deactivation of catalysts has substantially four causes:

Firstly, it is blocking of catalytic sites, either by the formation of a solid product that traps them (encapsulation) or by the formation of a stable compound with the active phase, such as the deposition of carbon under certain conditions in the reaction for reforming methane (J. R. Rostrup-Nielsen, J.-H. Bak Hansen, 1993, Journal of catalysis 144, 38-49; H. S. Bengaard, J. K. Norskov, J. S. Sechested, B. S. Clausen, L. P. Nielsen, A. M. Molenbroek, J. R. Rostrup-Nielsen, Journal of Catalysis, 2002, vol. 209, p 365) or the formation of sulfur which reacts with Ni to form nickel sulfide (NiS₂) that is a stable compound (P. Van Beurden, 2004, ECN report).

In order to overcome, for example, the problem of the formation of carbon deposits and encapsulation, research has been carried out on the development of ceramic materials capable of oxidizing carbon that is formed/deposited during the reaction (J. R. Rostrup Nielsen, J. H. Bak Hansen, 1993, Journal of catalysis 144, 38-49). Oxides capable of providing or conducting oxygen, such as Ce—ZrO₂ have shown good efficiency against deactivation of the catalyst by carbon deposition (F. B. Noronha, A. Shamsi, C. Taylor, E. C. Fendly, S. Stagg-Williams and D. E. Resasco, 2003 Catalysis Letters 90: 13-21; P. Van Beurden, 2004, ECN report; E. Ramirez-Cabrera, A. Atkinson and D. Chadwick, Catalytic steam reforming of methane over CeO.9GdO.1O₂₋ₓ; 2004 Applied Catalyst B 47: 127-131; international application published under number WO 2004/047985). Carbon is oxidized in the form of CO or CO₂ (M. V. M. Souza, M. Schmal. 2005, Applied Cata. A: General 281, p 19-24; international application published under number WO 02/20395). In the case of trapping with sulfur, treatment in a reducing or oxidizing environment is generally satisfactory.

The second cause is a change to the specific surface area of the support. The geometries of the support of the active phase are defined in order to provide the greatest possible exchange surface area with reactants and in order to limit charge losses in the catalyst bed. Active phase particles are distributed in a random manner at the surface and/or in the core of the support according to the preparative method used (extrusion, coating, spray drying etc). In general, at least two porosity levels are developed on the supports. The first is a macroporosity that depends on the geometry of the part and the second is a microporosity due to stacking of particles, generally ceramic, of which it consists. Now, when the catalyst is used at a high temperature (>700° C.), partial densification of the stack of particles (sintering) is activated. The exchange surface area with the atmosphere accordingly falls, with the risk of trapping active phase particles. The activity of the catalyst therefore decreases rapidly to reach an equilibrium level when all the porosity is filled. In general, this change takes place and is taken into account when the catalytic bed is dimensioned. During recent years, the development of metal or ceramic foams has been a valuable avenue of research for stabilizing the macroporosity of the support (A. S. Bodke, S. S. Bharadwaj, L. D. Schmidt. 1998, J. of Cata. 179, p 138-149; international application published under WO 02/066371; patent of the United States of America published under U.S. Pat. No. 6,726,853). This change in microstructure generally occurs during the first days of operation and when the operating parameters are modified towards even more severe conditions (increase in temperature and pressure).

The third cause of deactivation of catalysts is oxidation of the active phase. Catalysts are generally noble metals (Pt, Pd, Rh, Ir, etc) or transition metals (Ni, Co etc). Preparation of the catalysts, support and active phase is often carried out in an oxidizing atmosphere, which leads to the formation of oxides. Pretreatment in a reducing atmosphere is essential before use in order to convert these metal oxides into metals. However, the chemical reaction may involve oxidizing species likely to lead to the oxidation of active phase particles. It is often possible to regenerate the catalyst by treatment in a reducing atmosphere (patent of the United States of America published under U.S. Pat. No. 6,726,853) or by introducing, into the gas mixture entering the reactor, a reducing species that will decompose the oxide. Another solution consists of preparing a self-regenerating catalyst, of the Pd/LaMnO₃/La-γAl₂O₃ type, by forming reversible solid solutions between the active phase and a perovskite support. During heat treatment at 1000° C., Pd rises to the surface of the support while exhibiting good dispersion, and it is then oxidized into PdO while the temperature falls rapidly. Under the combustion conditions for methane, two catalytic sites are active: one at low temperature PdO and one at high temperature LaMnO₃. Above 700° C., palladium oxide is reduced to metallic palladium and loses its catalytic activity, the support then taking over in the mechanism of oxidizing methane. Above 800° C., a solid solution forms between palladium and perovskite. When the system cools, from a temperature above 800° C., the catalyst is regenerated. This regeneration method makes it possible to prevent an increase in the grain size of the catalyst and active perovskite support. This valuable functionality is linked to the capacity to form reversible solid solutions with perovskite above 800° C. (S. Cimino, L. Lisi, R. Pirone, G. Russo, 2004 Ind. Eng. Chem. Res. 43: 6670-6679).

Finally, the fourth cause of the deactivation of catalyst is the coalescence of active phase particles coming from the diffusion/segregation/sintering of the latter at the surface of the ceramic support. This is a considerable source of deactivation of the catalyst, mainly (i) if said ceramic support does not exhibit any physical or chemical affinity toward the active metal phase, (ii) if the BET surface area and its pore volume are virtually nil or (iii) if no surface roughness has developed (G. E. Dolev, G. S. Shter, Grader. 2003, J. of Cat., vol. 214, p 146-152; C. G. Granqvist, R. A Buhrman, Appl. Phys. Lett., 1975, vol 27, p 693; C. G. Granqvist, R. A Buhrman, Journal of Catalysis, 1976, vol 42, p 477; C. G. Granqvist, R. A Buhrman, Journal of Catalysis, 1977, vol 46, p 238; C. H. Bartholomew, App. Cata. General A, 1993, vol 107, p 1; J. R. Rostrup-Nielsen, J.-H Bak Hansen, 1993, Journal of Catalysis 144, 38-49). The initial activity of a catalyst, apart from the parameters referred to previously, depends on the distribution and size of particles of the active phase (patent of the United States of America published under U.S. Pat. No. 6,726,853). The smaller (nanometric) and better dispersed they are, the greater the number of exchanges with the reaction atmosphere. This also makes it possible in the case of the methane reforming reaction to limit the formation of carbon (European patent application published under number EP 1 449 581). An attempt is thus made in general to obtain perfectly dispersed nanometric particles, that is to say those isolated from each other (J. Wei, E Iglesia. 2004, J. of Cata. 224, p 370-383) and that are perfectly stable (anchorages to the support). However, when the catalyst is used at a high temperature, these small nanometric particles (2-50 nm) have the tendency to diffuse to the surface of the support and to coalesce (formation of micron-size clusters) to form larger and less active particles (G. E. Dolev, G. S Shter, Grader. 2003, J. of Cat. vol 214, p 146-152; C. H. Bartholomew, Appl. Cata. General A 1993, vol 107, p1). Slow catalyst de-activation is commonly observed through a fall in conversion and/or modification of selectivity.

The work described in the European patent published under EP 1 378 290, on nickel-based catalysts, discloses an attempt to limit diffusion of the active phase to the surface of the support (increase of particle size) by increasing its melting point. To this end, a metal, gold or silver, is added to nickel in order to produce a high melting point alloy. Although this solution limits diffusion of the active phase, it also brings about a large increase in costs with the use of such metals (Ag, Au) in the composition of the active phase.

Another solution for limiting the coalescence of active phase particles consists of carrying out a heat treatment in order to increase the size of the smallest particles. It may be considered that it consists of “artificially” aging the catalyst in a controlled manner before it is used. This solution necessarily brings about the wrong ratio between the mass of active phase introduced during the preparation and the actually active mass (patent application of the United States of America published under number US 2005/0049317).

The development of strong chemical interactions between the active phase and the support is also a very useful solution for limiting the surface diffusion of the active phase. Two approaches may be provided, the first by modifying the chemical composition of the support and the second by modifying the nature of the active phase (L. Mo, J. Fei, C. Huang, X. Zheng. 2003, J. Mol. Cata. A: Chemical 193, p 177-184; O. Yamazaki, K. Tomishige, K. Fujimoto. 1996, Applied Cata. A: General 136, p 49-56; R. M. Navarro, M. C. Alvarez-Galvan, M. Cruz Sanchez-Sanchez, F. Rosa, J. L. G. Fierro 2005, Applied Cata B: Environnement 55, p 229-241).

The international patent application published under number WO 02/066371 discloses a preparative method comprising the impregnation of alumina with a large specific surface area with Mg nitrate in order to form a spinel MgAl₂O₄. The active metal is then deposited on this material. The powder obtained in this way may then be deposited on a metal foam of the FeCrAlY type or any other support having a large exchange surface area. The spinel may be replaced by zirconia and deposition of the metal phase may be carried out after that of the spinel or zirconia on the foam. The authors have also undertaken to use such catalysts in microchannels. They show that they end up by reducing the contact time compared with conventional catalysts but they do not provide any explanations. However, the authors do not control the dispersion and size of the metal particles and limit the support to inert oxides.

International applications publishes under numbers WO 02/058829, WO 02/058830 and WO 2005/046850 disclose control of an architecture/microstructure by using ceramic blocking agents for various applications employing ceramic materials.

This is why the subject of the invention is a catalytic assembly designed to catalyze chemical reactions in a gaseous phase, consisting of a solid support, on the surface (Σ) of which an anchoring oxide (O) is attached, having a different chemical nature from that of said solid support (Σ), said anchoring oxide covering a non-zero area proportion of said surface of said solid support (Σ) and a metal phase (M) that is catalytically active for the chemical reaction considered, characterized in that said catalytically active metal phase (M) is anchored onto said solid support (Σ) via said anchoring oxide (O), that is itself grafted onto said solid support (Σ).

According to one feature of the present invention, a catalytically active metal phase (M) denotes in particular metals such as platinum, palladium, rhodium iridium, cobalt or nickel, and alloys containing said metals.

An anchoring oxide (O) denotes in particular oxides of boron, aluminum, gallium, cerium, silicon, titanium, zirconium, zinc, magnesium or calcium, mixed oxides of alkaline earth metals, of metals, the silicates of aluminum and/or magnesium; calcium phosphates and their derivatives; or among doped ceramic oxides that, at the temperature of use, are in the form of a crystal lattice having vacancies in oxide ions more particularly in the form of a cubic phase, a fluorite phase, a perovskite phase, of the Aurivillius type, of a Brownmillerite phase or of a pyrochlor phase. Examples of such oxides are those chosen from magnesium oxide (MgO), calcium oxide (CaO), aluminum oxide (Al₂O₃), gadolinium oxide (Gd₂O₃), yttrium oxide (Y₂O₃), titanium oxide (TiO₂), zirconium oxide (ZrO₂), ceria (CeO₂), the mixed oxides of strontium and aluminum SrAl₂O₄ or Sr₃Al₂O₆; the mixed oxides of cerium and gadolinium (CeₓGd₁₋ₓO_{2-δ}), the mixed oxides of cerium and zirconium (CeₓZr₁₋ₓO_{2-δ}), the mixed oxides of barium and titanium (BaTiO₃); the mixed oxide of calcium and titanium (CaTiO₃); mullite (2SiO₂ 3Al₂O₃), cordierite (Mg₂Al₄Si₅O₁₈) or the spinel phase MgAl₂O₄; hydroxyapatite Ca₁₀(PO₄)₆(OH)₂ or tricalcium phosphate Ca₃(PO₄)₂ or furthermore the oxide of lanthanum and nickel (LaNiO₃).

Examples of doped ceramic oxides that, at the temperature of use, are in the form of a crystal lattice having vacancies in oxide ions, are:

(a) Oxides of formula (I):

(MₐO_{b})₁₋ₓ(R_{c}O_{d})ₓ (I)

in which M represents at least one trivalent or tetravalent atom mainly chosen from bismuth (Bi), cerium (Ce), zirconium (Zr), thorium (Th), gallium (Ga) or hafnium (Hf), a and b are such that the structure MₐO_{b} is electrically neutral, R represents at least one divalent or trivalent atom mainly chosen from magnesium (Mg), calcium (Ca) or barium (Ba), strontium (Sr), gadolinium (Gd), scandium (Sc), ytterbium (Yb), yttrium (Y), samarium (Sm), erbium (Er), indium (In), niobium (Nb) or lanthanum (La), c and d are such that the structure R_{c}O_{d} is electrically neutral, x generally lies between 0.05 and 0.30 and more particularly between 0.075 and 0.15. Examples of such compounds of formula (I) are those of formula (Ia):

(ZrO₂)₁₋ₓ(Y₂O₃)ₓ (Ia)

in which x lies between 0.05 and 0.15,

or of formula (1b):

Ce₁₋ₓGdₓO_{2-δ}

in which x lies between 0.01 and 0.5,

or of formula (Ic):

Ce₁₋ₓZrₓO₂

in which x lies between 0.5 and 0.75.

Examples of doped ceramic oxides that, at the temperature of use, are in the form of a crystal lattice having vacancies in oxide ions, are furthermore:

(b) Perovskite materials, of formula (II):

[Ma₁₋ₓMa′ₓ][Mb_{1-y}Mb′_{y}]O_{3-w} (II)

in which Ma and Ma′, that are identical or different, are chosen from the families of the alkaline earths, the lanthanides or the actinides, more particularly from La, Ce, Pr, Nd, Pm, Sm, Eu, Gd, Tb, Dy, Ho, Er, Tm, Yb, Lu, Y or Mg, Ca, Sr or Ba, Mb and Mb′, that are identical or different, represent one of more atoms chosen from transition metals, and more particularly from Sc, Ti, V, Cr, Mn, Fe, Co, Ni, Cu, Zn or Ga, x and y, that identical or different, are greater than or equal to 0 and less than or equal to 1 and w is such that the structure in question is electrically neutral.

Examples of such compounds of formula (II) are lanthanum-calcium-manganites (CaᵤLaᵥMnO_{3-w}), lanthanum-strontium-manganites (LaᵤSrᵥMnO_{3-w}), lanthanum-strontium-cobaltites (LaᵤSrᵥCoO_{3-w}), lanthanum-calcium-cobaltites (CaᵤLaᵥCoO_{3-w}), gadolinium-strontium-cobaltites (GdᵤSr_{y}CoO_{3-w}), lanthanum-strontium-chromites (LaᵤSrᵥCrO_{3-w}), lanthanum-strontium-ferrites (LaᵤSrᵥFeO_{3-w}), lanthanum-strontium-transition metal-doped ferrites (LaᵤSrᵥFe_{c}Mb′_{d}O_{3-w}) such as lanthanum strontium-ferrocobaltites (LaᵤSrᵥCo_{d}Fe_{c}O_{3-w}), compounds for which the sums u+v and c+d are equal to 1 and w is such that the structure in question is electrically neutral; La_{0.6}Sr_{0.4}Co_{0.8}Fe_{0.2}O_{3-w}, La_{0.5}Sr_{0.5}Fe_{0.9}Ti_{0.1}O_{3-w}, La_{0.6}Sr_{0.4}Fe_{0.9}Ga_{0.1}O_{3-w}, La_{0.5}Sr_{0.5}Fe_{0.9}Ga_{0.1}O_{3-w} or La_{0.6}Sr_{0.4}Fe_{0.9}Ti_{0.1}O_{3-w}.

In the assembly as previously described, the active metal phase/blocking oxide couple should not form a eutectic above the temperature of use in order to prevent trapping of the active phase in a liquid compound at this temperature of use, which leads to loss of catalytic activity. Examples of such active metal phase/blocking oxide couples, are the Pt—CeO₂ and Rh—CeO₂, (Pt,Rh)—CeₓGd₁₋ₓO₂ or (Pt,Rh)—Y₂O₃—ZrO₂ couples. These stabilizing oxides may moreover provide oxygen for oxidizing any carbon deposits that may trap the active phase in the methane reforming reaction.

The material constituting the surface (Σ) of said support is chosen in particular from the oxides of boron, aluminum, gallium, cerium, silicon, titanium, zirconium, zinc, magnesium or calcium, the mixed oxides of alkaline earth metals, of metals, silicates of aluminum and/or magnesium; calcium phosphates and their derivatives; metal alloys of the Ni—Cr type that can be used at temperatures up to 1000° C. As an example of a support, there are for example smooth substrates without any roughness such as the surface of the metal plate type, or substrates of the metal foam, ceramic foam type or a metal substrate coated with a ceramic layer.

The object of the invention is also a method for preparing an assembly such as previously defined, comprising:

a step (a) of preparing a suspension (Sₒ) in a solvent comprising 5% to 50% by volume of an anchoring oxide powder (O) and possibly up to 25% by weight of one or more additives chosen from dispersing agents, binding agents and/or plasticizing agents;

a step (b) of depositing an anchoring oxide (O) on the solid support by applying said suspension (S_{O}) prepared in step (a) on the surface (Σ) of the solid support;

a step (c) of heat treating the anchoring oxide (O), deposited on the surface (Σ) of the solid support at a temperature between 300° and 1200° C.

a step (d) of impregnating a solution (S_{M}) of a precursor of the active metal phase (M) on the anchoring oxide (O), previously deposited on the surface (Σ) of the solid support;

a step (e) of decomposing the precursor of the active phase (M) impregnated on the anchoring oxide (O) by heat treatment at a temperature of between 200° C. and 900° C., in order to generate said active metal phase (M).

According to another feature of the method as defined above, it additionally includes a step (a1) of deagglomerating the suspension prepared in step (a) before putting step (b) into operation.

According to another feature of the method as defined above, it also includes a step (b1) of drying the anchoring oxide (O) deposited on the surface (Σ) of the solid support, before putting the step (c) into operation.

The object of the invention is also a variant of the method as previously defined, comprising the following steps:

a step (f) of drying the suspension of anchoring oxide (O) prepared in step (a) in order to eliminate solvent and to obtain a powder (P_{O}) comprising the anchoring oxide (O) and any additives;

a step (g) of mixing the powder (P_{O}) obtained in step (f), with the solution (S_{M}) of precursor of the active metal phase (M) in order to obtain a suspension (S_{OM});

a step (h) of drying said suspension (S_{OM}) obtained in step (g), until the solvent is completely eliminated;

a step (i) for heat treating at a temperature of between 200° C. and 900° C., a mixture obtained with step (h), in order to obtain a powder (P_{OM}) of anchoring oxide (O) impregnated with said active metal phase (M);

a step (j) of preparing a suspension (S′_{OM}) of the powder (P_{OM}) obtained in step (i) in a solvent;

a step (k) of depositing the anchoring oxide (O) impregnated with the active phase (M), on the surface (Σ) of the solid support, by applying said suspension (S′_{OM}) prepared in step (j), on the surface (Σ) of said support.

13. A variant of the method as defined in claim 9, comprising the following steps:

a step (f) of drying the anchoring oxide suspension (O) prepared in step (a), in order to eliminate solvent and to obtain a powder (P_{O}) comprising the anchoring oxide (O) and any additives;

a step (g) of mixing the powder (P_{O}) obtained in step (f), with the solution (S_{M}) of the precursor of the active metal phase (M) in order to obtain a suspension (S_{OM});

a step (m) of deagglomerating the (S_{OM}) obtained in step (g);

a step (n) of depositing the anchoring oxide (O) impregnated with the precursor of the active phase (M) on the surface (Σ) of the solid support, by applying said suspension (S_{OM}) deagglomerated in step (m), onto said surface (Σ);

a step (o) of heat treating, at a temperature of between 200° C. and 1200° C., said anchoring oxide (O) impregnated with the precursor of said active metal phase (M) deposited on the surface (Σ) of the solid support, in order to obtain said anchoring oxide (O) impregnated with said active metal phase (M).

The object of the invention is also a variant of the method as previously defined, comprising the following steps:

a step (f) of drying the suspension of anchoring oxide (O) prepared in step (a) in order to eliminate solvent and to obtain a powder (P_{O}) comprising the anchoring oxide (O) and any additives;

a step (g) of mixing the powder (P_{O}) obtained in step (f) with the solution (S_{M}) of the precursor of the active metal phase (M) in order to obtain a suspension (S_{OM});

a step (m) of deagglomerating the (S_{OM}) obtained in step (g);

a step (n) of depositing the anchoring oxide (O) impregnated with the precursor of the active phase (M) onto the surface (Σ) of the solid support, by applying said suspension (S_{OM}), deagglomerated in step (m), onto said surface (Σ);

a step (o) of heat treating, at a temperature between 200° C. and 1200° C., said anchoring oxide (O) impregnated with the precursor of said active metal phase (M), deposited on the surface (Σ) of the solid support, in order to obtain said anchoring oxide (O) impregnated with said active metal phase (M).

Variants of the methods as defined above may also include:

a step (l) for heat treating, at a temperature between 200° C. and 1200° C., the anchoring oxide (O) impregnated with said active metal phase (M), deposited onto the surface (Σ) of the solid support.

Such a method as previously described or its variants are for example put into practice in order to attach a catalytically active metal phase (M) onto the inner surface (Σ) of a reactor. As an example of such an application, a layer of catalyst for the oxidation of natural gas by oxygen is prepared on the face of a membrane of a catalytic membrane reactor. Oxygen is separated from a steam of air introduced on the other face of the membrane by ionic conduction through said membrane.

Applications aimed at by the object of the present invention relate for example to catalytic membrane reactors for the production of synthesis gas, to ceramic oxygen generators and to solid oxide fuel cells. In a general manner, the method described makes it possible to prepare any catalyst consisting of a solid support, whether active or not, and an active phase. Moreover, the methods developed are particularly suitable for producing catalyst deposits on parts with complex shapes or on surfaces that are difficult to access.

In the method or its variants, use of a nanometric powder of said anchoring oxide (O) makes it possible to deposit active metal particles in very narrow places, such as channels of the order of a millimeter in diameter, or in places that are difficult to access such as machined plates, the inside of tubes, cylinders and heat exchangers. Moreover, since small-size particles are very reactive, the heat treatment for attaching the blocking oxide to the support may be carried out at a moderate temperature, limiting the impact on other materials such as that of the surface (Σ) of the solid support. It is moreover possible to graft active phase particles onto coarser particles according to the desired application and the limitations of each application. Nanometric powders are understood to mean powders with particles having a diameter of between 1 and 800 nanometers.

Good dispersion of the active metal phase presents a considerable economic benefit, since it is possible to use it in a much smaller quantity. It therefore becomes possible to use more widely on the industrial scale noble metals such as platinum or rhodium that are much more catalytically active, but also more costly. This good dispersion of the catalytic metal phase also has a positive impact on the size of equipment, the catalyst being more efficient. The preparation of suspensions containing several active phases may also be easily envisaged, which facilitates the use of a binary active phase of the Pt—Rh type etc that is more stable than pure metals.

In the method and its variants as described above, impregnation of the metal phase on the oxide is carried out by spray coating, dip coating or spin coating or by electroless plating. Anchoring of the oxide, impregnated or not with the metal phase, on the surface (Σ) of the solid support, is carried out by slurry coating, spray coating, dip coating or spin coating.

The following account explains the invention without however limiting it.

The invention as described above is based on the concept of a blocking oxide and deals in particular with preparative methods enabling the microstructure of a catalyst material to be controlled, nanometric particles of the active phase to be dispersed on the support and the stability of the size of active phase particles to be ensured, as well as their dispersion with time.

1—Blocking Oxide Concept

As described in the international application published under number WO 2005/046850, addition of a blocking agent limits the growth of grain in ceramic parts by limiting the diffusion of material within the volume. It has been assumed that a blocking oxide could also limit the surface diffusion of active phase particles of a catalyst.

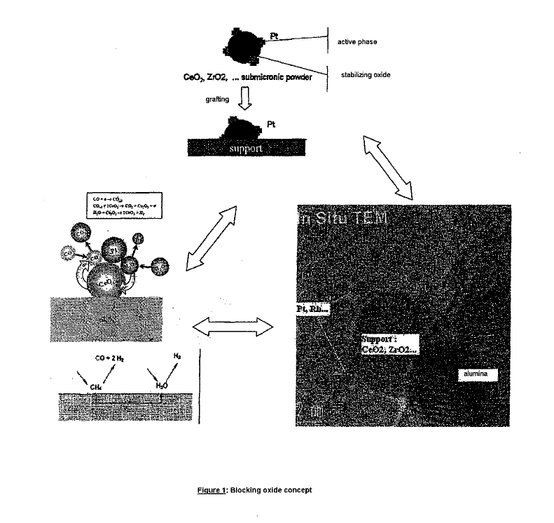

FIG. 1 illustrates this concept. Active phase particles are first of all grafted onto a blocking oxide that may for example be CeO₂, ZrO₂ or Ce₁₋ₓZrₓO, in powder form. It will preferably by capable of storing, releasing or conducting oxygen into its crystal lattice. The blocking oxide covered with the active phase is then deposited on the surface of a support by any suitable technique. It will be preferred to coat from a suspension that makes it possible to obtain a homogeneous deposit even on parts with a complex shape or those having zones that are difficult to access. In the latter case, the use of a nanometric blocking oxide will be preferred so as to facilitate penetration into narrow zones, without risk of clogging. The photograph of FIG. 1 demonstrates that the surface of the support on which the oxide impregnated with metal is grafted, is smooth and without roughness and that the metal is anchored on said support by means of the oxide.

2—Preparative Methods

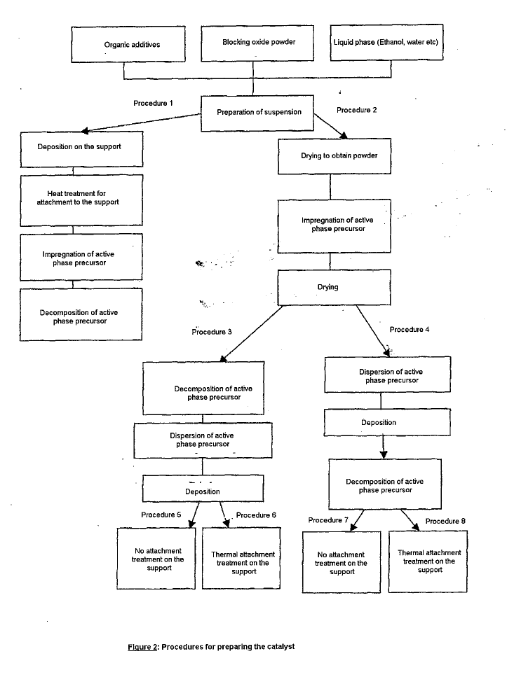

FIG. 2 is a diagram showing the method that is the object of the present invention and its variants.

The final microstructure of the catalyst consists of an active phase grafted onto a blocking oxide, that is itself attached to a support, as shown in the preceding FIG. 1.

2.1—Preparation of the Blocking Oxide Suspension

The first step of the preparative methods is common. It consists of producing a suspension of the blocking oxide powder. Nanometric powders have the tendency to agglomerate naturally due to the small size of the particles. It is necessary to deagglomerate this powder before it is used. This step is generally more effective in a liquid medium. Moreover, in order to overcome the natural tendency for reagglomeration, organic compounds are added (dispersants etc), that stabilize the dispersion state.

The blocking oxide powders used to produce active phase deposits have a mean grain size less than 100 nanometers and a specific surface area of a few tens of m²/g.

2.1.1—Choice of Organic Additives

Suspensions of ceramic particles require the use of organic compounds to stabilize them. The main additives are dispersants, binders and plasticizers.

The dispersant is chosen according to the nature of the blocking oxide powder. Chemical compatibility should be obtained between these two elements. The quantity of dispersant to be added is determined from the specific surface area of the powder.

Binders and plasticizers may be incorporated in the suspension in order to modify its rheological properties. They are particularly valuable if the preparation is carried out by spraying, in order to avoid running of the suspension on vertical zones of the part.

2.1.2—Choice of the Liquid Phase

The liquid phase will be chosen from the following criteria:
the nature of the organic compounds that should be soluble in this phase
application facilities (toxicity etc)
the deposition method.

For example, ethanol is preferred when a rapid drying rate is necessary (deposition by brush). Water is preferred if the drying rate is not a limiting factor.

2.1.3—Protocol for Deagglomerating the Blocking Oxide Powder

This step is important for two reasons. The first is that of having a powder in a quite fine suspension in order to infiltrate narrow zones of the part. It is in general estimated that a ratio of 10 to 20 is necessary between the diameter of the particles and the diameter of the smallest hole capable of being infiltrated without clogging, due to an accumulation of solid particles. The second reason concerns the catalytic activity of the active phase, which depends on the developed surface area. The larger the latter, the larger the contact surface area between the reactants and the catalytic sites and the higher the efficiency of the catalyst.

For example, the powder may be dispersed in ethanol over 12 to 15 hours with 11% by volume of powder based on the volume of ethanol and 1% by weight of dispersant CP 213™ based on the weight of powder.

2.2.2 Procedure 1—Impregnation of the Active Phase After Deposition of the Blocking Oxide on the Support

A first preparative procedure consists of depositing the blocking oxide powder onto the support before grafting the particles of active phase thereon. The suspension of nanometric blocking oxide powder is deposited directly onto the support by brush, spraying or immersion. Drying at 60° C. enables ethanol to be eliminated and heat treatment between 500° C. and 800° C. for 2 hours leads to attachment of the blocking oxide powder onto the support. The active phase is then impregnated in the form of a precursor in aqueous solution, for example Rh(NO₃)₃.2H₂O (1% by weight of Rh). The concentration of this solution is controlled according to the desired active phase content. The precursor is then decomposed at 500° C. for 2 hours.

2.2.3 Procedure 2—Impregnation of the Active Phase on the Blocking Oxide Before Deposition on the Support

A second preparative procedure consists of drying the blocking oxide powder (at 60° C. if the liquid phase is ethanol), after dispersion, in order to graft on the active phase. The latter is brought in the form of an aqueous solution, for example Rh(NO₃)₃.2H₂O (1% by weight of Rh), of which the concentration determines the final active phase content. Several successive impregnations may be performed with or without drying at 40° C. between each deposition. Water is completely eliminated at 180° C. over 12 to 15 hours.

Two possibilities are then offered to us, procedures 3 and 4.

2.3.1 Procedure 3

The active phase precursor, deposited on the blocking oxide powder, is decomposed between 400° C. and 600° C. A suspension of this powder is then prepared as previously described, in order to deposit it by brush, spraying or immersion. Heat treatment between 500° C. and 1000° C. enables the blocking oxide to be attached to the support (Procedure 6). This treatment is not obligatory, since it may form the subject of a procedure for starting up the installation (Procedure 5).

2.3.2 Procedure 4

The blocking oxide powder grafted with the active phase precursor is put into suspension and once again deagglomerated as previously described. The blocking oxide is deposited by brush, spraying or immersion. The active phase precursor is then decomposed by heat treatment between 400° C. and 600° C. A second heat treatment between 500° C. and 1000° C. may then enable the blocking oxide to be attached to the support (Procedure 8). This treatment is not obligatory, since it may form the subject of a procedure for starting up the installation (Procedure 7).

Decomposition of the precursor and attachment may also be carried out during the same heat treatment.

3. Examples of Embodiments

3.1 Rhodium (Rh; active phase) deposited+impregnated on gadolinium oxide (Gd₂O₃; blocking oxide) on an alumina support (Al₂O₃).

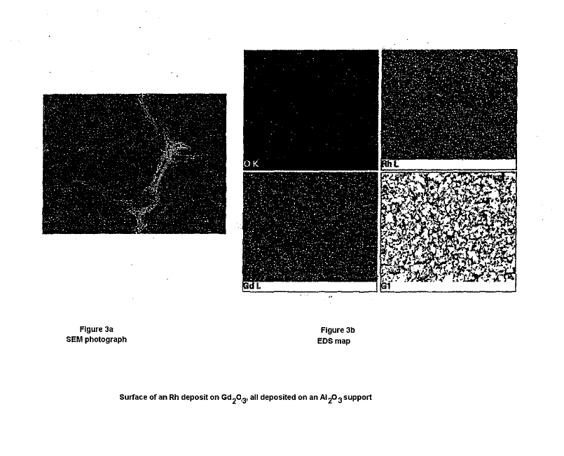

FIG. 3A is a photograph taken with the scanning electron microscope (SEM) of the surface of an Rh deposit on a blocking oxide Gd₂O₃, all deposited on an Al₂O₃ support, following procedures 2, 3 and 5 of the method shown diagrammatically in FIG. 2. Decomposition of the active phase precursor is carried out at 450° C. over 2 hours. FIG. 3B is an EDS (Energy Dispersive Spectroscopy) map prepared on each sample. It reveals excellent distribution of rhodium on the surface of the sample.

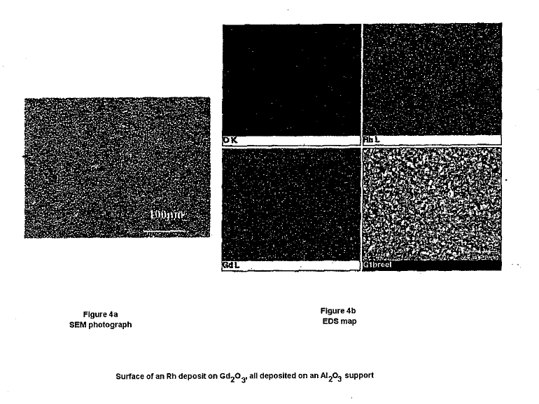

FIG. 4A is a photograph taken with the scanning electron microscope (SEM) of the surface of an Rh deposit on a blocking oxide Gd₂O₃, all deposited on an Al₂O₃, following procedures 2, 4 and 8 shown schematically in FIG. 2. Final treatments for attaching and decomposing the active phase precursor are carried out simultaneously at 500° C. over 2 h. FIG. 4B is an EDS performed on this sample. It also demonstrates excellent distribution of rhodium on the surface of the sample.

3.2—Deposition of Rh (active phase)+ZrO₂ (blocking oxide) on an Al₂O₃ support.

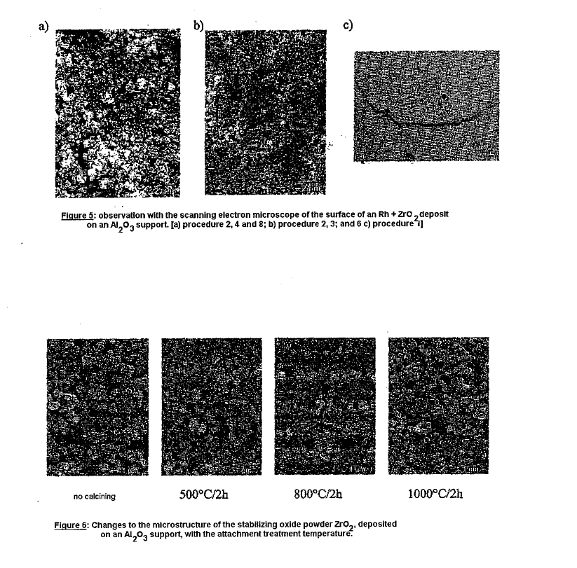

FIG. 5 is a collection of photographs taken with the scanning electron microscope of Rh+ZrO₂ deposits on an Al₂O₃ support following three preparative procedures [FIG. 5a): Procedures 2, 4 and 8; FIG. 5b): Procedures 2, 3 and 6; FIG. 5c): Procedure 1] as described in FIG. 2. EDS measurements do not enable the various materials to be identified since their atomic masses are very close to each other. Satisfactory attachment of the deposit is noted with the three preparative procedures.

FIG. 6 consists of observations with the scanning electron microscope of the surface with ZrO₂ deposits on an Al₂O₃ support, treated at various temperatures. The blocking oxide ZrO₂ exhibits excellent thermal stability. The size of the grains does not vary up to 1000° C. This point is important for preventing encapsulation of the active phase that could occur if the blocking oxide on which it is grafted becomes densified.

The method and its variants, that are the subject of the present invention, therefore make it possible to produce a catalyst consisting of a solid support (support), a blocking (or stabilizing or grafting) oxide, whether active or not, and an active metal phase, in which dispersion of the active phase is ensured by grafting (anchoring) it onto the blocking oxide before or after it is deposited on the support.

Strong interactions between the active phase and the blocking oxide limit the phenomenon of diffusion/segregation/sintering-coalescence of active phase particles substantially associated with surface diffusion. This oxide may also have a catalytic effect on the reactions employed. As an example, mention will be made of the limitation of a carbon deposit, responsible for a reduction in catalytic activity, in methane reforming reactions. In the presence of a support of the oxide type capable of storing and releasing oxygen, the carbon formed on active sites is oxidized to CO or CO₂.

1-17. (canceled)

18. A catalytic assembly designed to catalyze chemical reactions in a gaseous phase, comprising a solid support, on the surface (Σ) of which an anchoring oxide (O) is attached, having a different chemical nature from that of said solid support (Σ), said anchoring oxide covering a non-zero area proportion of said surface of said solid support (Σ) and a metal phase (M) that is catalytically active for the chemical reaction considered, characterized in that said catalytically active metal phase (M) is anchored onto said solid support (Σ) via said anchoring oxide (O), that is itself grafted onto said solid support (Σ) and in that the anchoring oxide (O) is selected from the group consisting of:
doped ceramic oxides selected from the group consisting of the formula Ce₁₋ₓGdₓO_{2-δ} in which x lies between 0.01 and 0.5 and δ is such that the material is electrically neutral and the formula Ce₁₋ₓZrₓO₂ in which x lies between 0.5 and 0.75; and
perovskite materials selected from the group consisting of:
lanthanum-calcium-manganites (CaᵤLaᵥMnO_{3-w}),
lanthanum-strontium-manganites (LaᵤSrᵥMnO_{3-w}),
lanthanum-strontium-cobaltites (LaᵤSrᵥCoO_{3-w}),
lanthanum-calcium-cobaltites (CaᵤLaᵥCoO_{3-w}),
gadolinium-strontium-cobaltites (GdᵤSr_{y}CoO_{3-w}),
lanthanum-strontium-chromites (LaᵤSrᵥCrO_{3-w}),
lanthanum-strontium-ferrites (LaᵤSrᵥFeO_{3-w}), and
lanthanum-strontium-transition metal-doped ferrites (LaᵤSrᵥFe_{c}Mb′_{d}O_{3-w}) wherein u+v=1, c+d=1, and w is such that the material is electrically neutral.

19. The assembly of claim 18, wherein the catalytically active metal phase (M) is selected from the group consisting of platinum, palladium, rhodium iridium, cobalt, nickel, and alloys thereof.

20. The assembly of claim 18, wherein said anchoring oxide (O) is selected from the group consisting of La_{0.6}Sr_{0.4}Co_{0.8}Fe_{0.2}O_{3-w}, La_{0.5}Sr_{0.5}Fe_{0.9}Ti_{0.1}O_{3-w}, La_{0.6}Sr_{0.4}Fe_{0.9}Ga_{0.1}O_{3-w}, La_{0.5}Sr_{0.5}Fe_{0.9}Ga_{0.1}O_{3-w}, and La_{0.6}Sr_{0.4}Fe_{0.9}Ti_{0.1}O_{3-w}.

21. The assembly of claim 18, wherein the material constituting the surface (Σ) of said support is selected from the group consisting of: boron oxides; aluminum oxides; gallium oxides; cerium oxides; silicon oxides; titanium oxides; zirconium oxides; zinc oxides; magnesium oxides; calcium oxides; mixed oxides of alkaline earth metals; metals; the silicates of aluminum and/or magnesium; calcium phosphates and derivatives thereof; and Ni—Cr metal alloys.

22. A method for preparing a catalytic assembly designed to catalyze chemical reactions in a gaseous phase, the catalytic assembly comprising a solid support, on the surface (Σ) of which an anchoring oxide (O) is attached, having a different chemical nature from that of said solid support (Σ), the anchoring oxide covering a non-zero area proportion of said surface of said solid support (Σ) and a metal phase (M) that is catalytically active for the chemical reaction considered, wherein said catalytically active metal phase (M) is anchored onto said solid support (Σ) via said anchoring oxide (O) which is grafted onto said solid support (Σ), said method comprising the steps of:
(a) preparing a suspension (S_{O}) in a solvent comprising 5% to 50% by volume of powdered anchoring oxide (O) and up to 25% by weight of one or more additives selected from the group consisting of dispersing agents, binding agents, plasticizing agents, and mixtures thereof;
(b) depositing the powdered anchoring oxide (O) on the solid support by applying said suspension (S_{O}) prepared in said step (a) on the surface (Σ) of the solid support;
(c) heat treating the anchoring oxide (O) deposited on the surface (Σ) of the solid support at a temperature between 200° and 900° C.;
(d) impregnating a solution (S_{M}) of a precursor of the active metal phase (M) on the anchoring oxide (O) that was previously deposited on the surface (Σ) of the solid support;
(e) decomposing the precursor of the active phase (M) impregnated on the anchoring oxide (O) by heat treatment at a temperature of between 200° C. and 900° C., in order to generate said active metal phase (M).

23. The method of claim 22, further comprising the step of:
(a1) deagglomerating the suspension prepared in said step (a) before performing said step (b).

24. The method of claim 22, further comprising the step of:
(b1) drying the anchoring oxide (O) deposited on the surface (Σ) of the solid support before performing said step (c).

25. The method of claim 22, further comprising the steps of:
(f) drying the suspension of anchoring oxide (O) prepared in said step (a) in order to eliminate solvent and to obtain a powder (P_{O}) comprising the anchoring oxide (O) and said one or more additives;
(g) mixing the powder (P_{O}) obtained in said step (f) with the solution (S_{M}) of precursor of the active metal phase (M) in order to obtain a suspension (S_{OM});
(h) drying said suspension (S_{OM}) obtained in said step (g) until the solvent is completely eliminated;
(i) heat treating the mixture obtained with said step (h) at a temperature of between 200° C. and 900° C. in order to obtain a powder (P_{OM}) of said anchoring oxide (O) impregnated with said active metal phase (M);
(j) preparing a suspension (S′_{OM}) of the powder (P_{OM}) obtained in said step (i) in a solvent;
(k) depositing the anchoring oxide (O) impregnated with the active phase (M), on the surface (Σ) of the solid support by applying said suspension (S′_{OM}) prepared in said step (j) on the surface (Σ) of said support.

26. The method of claim 22, further comprising the following steps:
(f) drying the anchoring oxide suspension (O) prepared in said step (a) in order to eliminate the solvent and to obtain a powder (P_{O}) comprising the anchoring oxide (O) and said one or more additives;
(g) mixing the powder (P_{O}) obtained in said step (f) with the solution (S_{M}) of the precursor of the active metal phase (M) in order to obtain a suspension (S_{OM});
(m) deagglomerating the (S_{OM}) obtained in said step (g);
(n) depositing the anchoring oxide (O) impregnated with the precursor of the active phase (M) on the surface (Σ) of the solid support by applying said suspension (S_{OM}) deagglomerated in said step (m) onto said surface (Σ);
(o) heat treating said anchoring oxide (O) impregnated with the precursor of said active metal phase (M) deposited on the surface (Σ) of the solid support at a temperature of between 200° C. and 1200° C. in order to obtain said anchoring oxide (O) impregnated with said active metal phase (M).

27. The method of claim 24, further comprising the step of:
heat treating the anchoring oxide (O) impregnated with said active metal phase (M), deposited onto the surface (Σ) of the solid support at a temperature between 200° C. and 1200° C.

28. A catalytic assembly prepared according the method of claim 27.

29. A method of reacting oxygen with natural gas, comprising the steps of:
providing the catalytic assembly of claim 28; and
providing a stream of natural gas on an inner side of the assembly;
providing a stream of air on an outer side of the assembly;
allowing oxygen to be separated from the air stream by electrochemical means through the catalytic assembly; and
allowing the natural gas and the oxygen to react.

30. The assembly of claim 18, wherein the anchoring oxide (O) is a a lanthanum strontium-ferrocobaltite (LaᵤSrᵥCo_{d}Fe_{c}O_{3-w}).
